(19) United States
(12) Patent Application Publication
(10) Pub. No.: US 2014/0172664 A1
(43) Pub. Date: Jun. 19, 2014

(54) Processing of Exercised Options

(71) Applicant: CHICAGO MERCANTILE EXCHANGE, INC., Chicago, IL (US)

(72) Inventors: Dhiraj Bawadhankar, Aurora, IL (US); Courtney Claussen, Chicago, IL (US); Brian Sayers, Naperville, IL (US); Fateen Sharaby, Hoboken, NJ (US)

(73) Assignee: CHICAGO MERCANTILE EXCHANGE, INC., Chicago, IL (US)

(21) Appl. No.: 13/720,064

(22) Filed: Dec. 19, 2012

(51) Int. Cl. G06Q 40/04

(52) U.S. Cl. CPC G06Q 40/04
USPC 705/37

(57) ABSTRACT

A computer system may receive exercise instruction data for an option. The exercise instruction data may indicate exercise of an option on which optionor and optionee interests are based. The computer system may access stored option data. The option data may identify multiple optionor interests based on options of the same type as the exercised option. The computer system may select one of the optionor interests. The selecting may be performed in response to the exercise instruction data and without regard to whether the selected optionor interest is based on the exercised option. The computer system may transmit, to a computer system associated with a holder of the selected optionor interest, assignment data indicating assignment of an interest in an optioned contract created as a result of the option exercise.

### BACKGROUND

An option is an undertaking by which a first party has the right, but not the obligation, to enter into an agreement at a future time. A second party to an option has an obligation to enter that agreement if the first party exercises its right. Many types of agreements can be the agreement that is the subject of an option, i.e., serve as an optioned agreement. Some options and their underlying optioned agreements may be “listed” and multilaterally traded through an exchange. Other options and/or their underlying optioned agreements may be “over the counter” (OTC), e.g., subject to bilateral negotiation and execution.

Exercise of an OTC option and concomitant assignment of an optioned agreement created as a result of the option exercise conventionally involves bilateral communication between holders of opposite positions in the option. For example, the holder of a one position in the option may directly inform the holder of the opposite position of an intent to exercise the option. As OTC options move to a centrally-cleared environment, however, anonymity among parties to exercised OTC options is desirable. Such anonymity is generally inconsistent with conventional methods of OTC option exercise and assignment. For example, anonymity can require that an optioned agreement created as a result of option exercise be assigned to a party who was not an original party to the exercised option. Moreover, and in both the OTC and listed option domains, there can be undesirable delay between the time that an option is exercised and the time that an assignee of an optioned contract created as a result of the exercised option is notified of the assignment.

For these and other reasons, there remains a need for improved methods of processing exercised OTC and listed options.

### SUMMARY

This Summary is provided to introduce a selection of concepts in a simplified form that are further described below in the Detailed Description. This Summary is not intended to identify key or essential features of the invention.

In at least some embodiments, a computer system may receive exercise instruction data for an option. The exercise instruction data may indicate exercise of an option on which optionor and optionee interests are based. The computer system may access stored option data. The option data may identify multiple optionor interests based on options of the same type as the exercised option. The computer system may select one of the optionor interests. The selecting may be performed in response to the exercise instruction data and without regard to whether the selected optionor interest is based on the exercised option. The computer system may transmit, to a computer system associated with a holder of the selected optionor interest, assignment data indicating assignment of an interest in an optioned contract created as a result of the option exercise.

Embodiments include, without limitation, methods for processing of option execution, exercise and/or assignment, computer systems configured to perform such methods, and computer-readable media storing instructions that, when executed, cause a computer system to perform such methods.

### BRIEF DESCRIPTION OF THE DRAWINGS

Some embodiments are illustrated by way of example, and not by way of limitation, in the figures of the accompanying drawings and in which like reference numerals refer to similar elements.

FIG. 1 shows an exemplary trading network environment for implementing trading systems and methods according to at least some embodiments.

FIGS. 2A through 2C are block diagrams showing operations performed in connection with processing of executed options according to at least some embodiments.

FIG. 3 shows operations performed in connection with exercise of an option, and assignment of an interest in an optioned contract created as a result of that option exercise, according to at least some embodiments.

FIG. 4 is a flow chart showing steps performed in methods according to some embodiments.

### DETAILED DESCRIPTION

In the following description of various embodiments, reference is made to the accompanying drawings, which form a part hereof, and in which various embodiments are shown by way of illustration. It is to be understood that there are other embodiments and that structural and functional modifications may be made. Embodiments of the present invention may take physical form in certain parts and steps, examples of which will be described in detail in the following description and illustrated in the accompanying drawings that form a part hereof.

Various embodiments may comprise a method, a computer system, and/or a computer program product. Accordingly, one or more aspects of one or more of such embodiments may take the form of an entirely hardware embodiment, an entirely software embodiment and/or an embodiment combining software and hardware aspects. Furthermore, such aspects may take the form of a computer program product stored by one or more non-transitory computer-readable storage media having computer-readable program code, or instructions, embodied in or on the storage media. The term “computer-readable medium” or “computer-readable storage medium” as used herein includes not only a single medium or single type of medium, but also a combination of one or more media and/or types of media. Such a non-transitory computer-readable medium may store computer-readable instructions (e.g., software) and/or computer-readable data (i.e., information that may or may not be executable). Any suitable computer readable media may be utilized, including various types of non-transitory computer readable storage media such as hard disks, CD-ROMs, optical storage devices, magnetic storage devices, FLASH memory and/or any combination thereof. The term “computer-readable medium” or “computer-readable storage medium” could also include an integrated circuit or other device having hard-coded instructions (e.g., logic gates) that configure the device to perform one or more operations.

Aspects of method steps described in connection with one or more embodiments may be executed by one or more processors associated with a computer system (such as exchange computer system 100 and/or other computers described below). As used herein, a “computer system” could be a single computer or could comprise multiple computers. When a computer system comprising multiple computers performs a method, various steps could be performed by different ones of those multiple computers. Processors of a computer system may execute computer-executable instructions stored on non-transitory computer-readable media. Embodiments may also be practiced in a computer system forming a distributed computing environment, with tasks performed by remote processing devices that are linked through a communications network. In a distributed computing environment, program components may be located in both local and remote computer storage media including memory storage devices.

### Exemplary Operating Environment

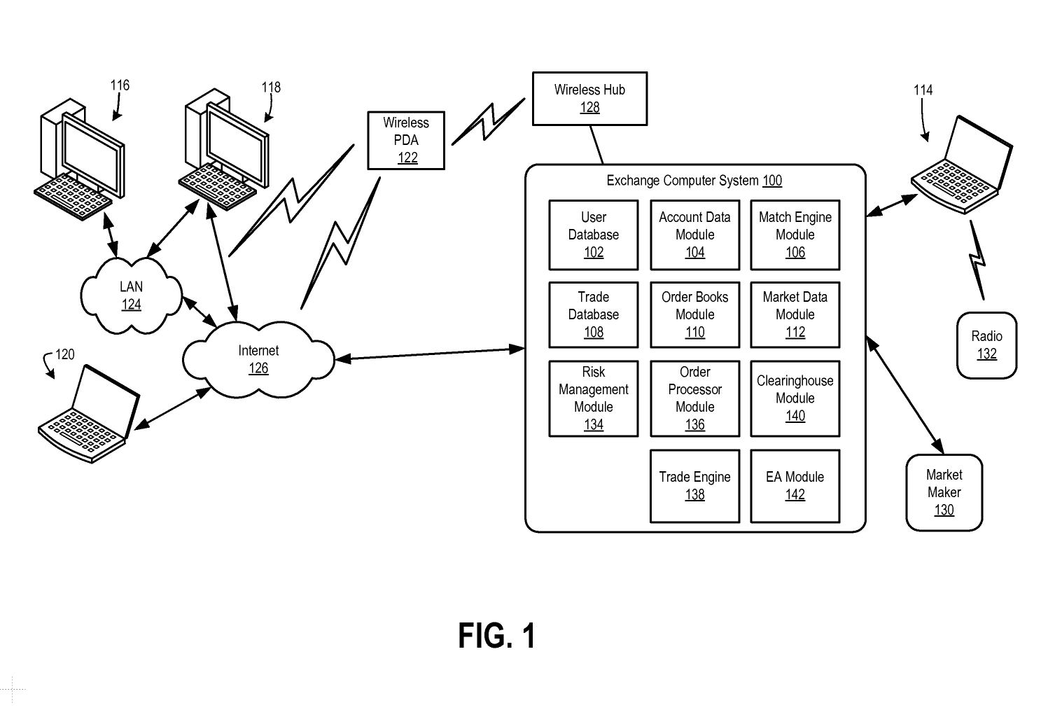

Aspects of at least some embodiments can be implemented with computer systems and computer networks that allow users to communicate trading information. An exemplary trading network environment for implementing trading systems and methods according to at least some embodiments is shown in FIG. 1. The implemented trading systems and methods can include systems and methods that facilitate option execution, exercise and/or assignment such as are described herein.

Computer system 100 can be operated by a financial product exchange and configured to perform operations of the exchange for, e.g., trading and otherwise processing various financial products. Financial products of the exchange may include, without limitation, futures contracts, options on futures contracts (“futures contract options”), and other types of derivative contracts. Financial products traded or otherwise processed by the exchange may include over-the-counter (OTC) options, swaps, OTC forwards, and other types of financial products that may be executed as part of bilateral negotiations between two entities.

Computer system 100 receives orders for financial products, matches orders to execute trades, transmits market data related to orders and trades to users, and performs other operations associated with a financial product exchange. Exchange computer system 100 may be implemented with one or more mainframe, desktop or other computers. In one embodiment, a computer device uses a 64-bit processor. A user database 102 includes information identifying traders and other users of exchange computer system 100. Data may include user names and passwords. An account data module 104 may process account information that may be used during trades. A match engine module 106 is included to match prices and other parameters of bid and offer orders. Match engine module 106 may be implemented with software that executes one or more algorithms for matching bids and offers.

A trade database 108 may be included to store information identifying trades and descriptions of trades. In particular, a trade database may store information identifying the time that a trade took place and the contract price. An order book module 110 may be included to store prices and other data for bid and offer orders, and/or to compute (or otherwise determine) current bid and offer prices. A market data module 112 may be included to collect market data, e.g., data regarding current bids and offers for futures contracts, futures contract options and other derivative products. Module 112 may also prepare the collected market data for transmission to users. A risk management module 134 may be included to compute and determine a user's risk utilization in relation to the user's defined risk thresholds. An order processor module 136 may be included to decompose delta based and bulk order types for further processing by order book module 110 and match engine module 106.

A clearinghouse module 140 may be included as part of exchange computer system 100 and configured to carry out clearinghouse operations. Module 140 may receive data from trade database 108 and/or other modules of computer system 100, including exercise and assignment (EA) module 142 (described below), regarding trades of futures contracts, futures contracts options, OTC options and contracts, and other financial products. Clearinghouse module 140 may facilitate the financial product exchange acting as one of the parties to every traded contract or other product. For example, computer system 100 may match an offer by party A to sell an exchange-traded financial product with a bid by party B to purchase a like exchange-traded financial product. Module 140 may then create an exchange-traded financial product between party A and the exchange and an offsetting second exchange-traded financial product between the exchange and party B. Module 140 may similarly create offsetting contracts when creating contracts as a result of an option exercise. As another example, and as discussed below, clearinghouse module 140 may receive data identifying an executed OTC option and the parties who bilaterally executed an agreement that created the executed OTC option. Module 140 may also be configured to perform other clearinghouse operations. As a further example, module 140 may maintain margin accounts for clearing members. In those accounts, module 140 may store and maintain data regarding the values of various contracts and other instruments, determine mark-to-market and final settlement amounts, confirm receipt and/or payment of amounts due from margin accounts, confirm satisfaction of final settlement obligations (physical or cash), etc.

EA module 142 receives and processes data regarding execution, exercise and/or assignment of OTC option contracts. Various operations performed by EA module 142 in at least some embodiments are further described below.

Each of modules 102 through 142 could be separate software components executing within a single computer, separate hardware components (e.g., dedicated hardware devices) in a single computer, separate computers in a networked computer system executing software corresponding to one or more operations, or any combination thereof (e.g., one or more computers in a networked system may execute software modules corresponding more than one of modules 102-142).

Computer device 114 is shown directly connected to exchange computer system 100. Exchange computer system 100 and computer device 114 may be connected via a T1 line, a common local area network (LAN) or other mechanism for connecting computer devices. Computer device 114 is shown connected to a radio 132. The user of radio 132 may be a trader or exchange employee. The radio user may transmit orders or other information to a user of computer device 114. The user of computer device 114 may then transmit the trade or other information to exchange computer system 100.

Computer devices 116 and 118 are coupled to a LAN 124. LAN 124 may implement one or more of the well-known LAN topologies and may use a variety of different protocols, such as Ethernet. Computers 116 and 118 may communicate with each other and other computers and devices connected to LAN 124. Computers and other devices may be connected to LAN 124 via twisted pair wires, coaxial cable, fiber optics, radio links or other media.

A wireless personal digital assistant device (PDA) 122 may communicate with LAN 124 or the Internet 126 via radio waves. PDA 122 may also communicate with exchange computer system 100 via a conventional wireless hub 128. As used herein, a PDA includes mobile telephones and other wireless devices that communicate with a network via radio waves.

FIG. 1 also shows LAN 124 connected to the Internet 126. LAN 124 may include a router to connect LAN 124 to the Internet 126. Computer device 120 is shown connected directly to the Internet 126. The connection may be via a modem, DSL line, satellite dish or any other device for connecting a computer device to the Internet. Computers 116, 118 and 120 may communicate with each other via the Internet 126 and/or LAN 124.

One or more market makers 130 may maintain a market by providing constant bid and offer prices for a derivative or security to exchange computer system 100. Exchange computer system 100 may also include trade engine 138. Trade engine 138 may, e.g., receive incoming communications from various channel partners and route those communications to one or more other modules of exchange computer system 100.

One skilled in the art will appreciate that numerous additional computers and systems may be coupled to exchange computer system 100. Such computers and systems may include, without limitation, additional clearing systems, regulatory systems and fee systems.

The operations of computer devices and systems shown in FIG. 1 may be controlled by computer-executable instructions stored on non-transitory computer-readable media. For example, computer device 116 may include computer-executable instructions for receiving market data from exchange computer system 100 and displaying that information to a user. As another example, EA module 142, clearinghouse module 140 and/or other modules of exchange computer system 100 may include computer-executable instructions for performing operations associated with option execution, exercise and/or assignment such as are described herein.

Of course, numerous additional servers, computers, handheld devices, personal digital assistants, telephones and other devices may also be connected to exchange computer system 100. Moreover, one skilled in the art will appreciate that the topology shown in FIG. 1 is merely an example and that the components shown in FIG. 1 may be connected by numerous alternative topologies.

### Exemplary Embodiments

In at least some embodiments, exchange computer system 100 (or “system 100”) receives, stores, generates and/or otherwise and processes data associated with options. In some embodiments, those options may result from bilaterally executed OTC agreements. For example, and as explained in detail below, two parties may negotiate directly with each other regarding pricing and other terms for one or more options. Using an affirmation platform computer system, which may be distinct from system 100, those two parties may then communicate data to system 100 regarding the executed agreement and the options to which that executed agreement relate. Other parties may similarly bilaterally negotiate OTC option agreements and communicate data regarding those executed agreements and options to system 100. As used herein, an executed option is an option that has been created as a result of bilateral negotiation and execution of an OTC agreement, as a result of trading on an exchange, or in some other manner.

System 100 may also receive, generate and/or otherwise process data in connection with exercise of OTC options. For example, a holder of a first interest in a previously executed option may exercise that option. Upon receipt of data indicating that exercise, system 100 may select a second interest in an option of the same type. System 100 may then assign to the holder of that second option interest an interest in a contract that corresponds to the exercised option. System 100 may then notify the holder of the selected short option interest of the assignment. That notification may occur immediately or may occur after expiration of a predetermined time period. After assignment of the contract interest, system 100 may then transmit data to one or more computer systems. Those computer systems may be associated with one or more clearing member firm(s) associated with the exercising holder of the first option interest and with the holder of the selected short option interest, and/or associated with other relevant parties.

In other embodiments, system 100 may perform similar operations in connection with exchange-traded options. Additional aspects of operations performed or performable by system 100 (or by other computer systems) in various embodiments are described below.

An option is an undertaking in which a first party (or “optionee”) has the right, but not the obligation, to enter into an agreement (or “optioned agreement”) at a future time. The second party to an option (or “optionor”) has an obligation to enter into the optioned agreement if certain conditions occur. Each of the first party and the second party thus has a different interest in the option. An optionor may often receive money or some other consideration in return for the option interest acquired by the optionee.

Once it has been executed, an option may be “exercised” or “abandoned.” When an option is abandoned, the optioned agreement is not created. An abandonment may be express. For example, an optionee might affirmatively indicate that it will not exercise the option. If an option has an expiration date, the option might also be abandoned if it is not exercised prior to the expiration date.

When an option is exercised, the optioned agreement is created. The optionee and an optionor may then enter into the created agreement and become counterparties thereto. In some embodiments, option exercise may actually result in creation of two instances of the optioned agreement. The first instance of that agreement may have the optionee as one party and an exchange (or other entity) as the counterparty. The second instance of that agreement may have an optionor as one party and an exchange (or other entity) as the counterparty. However, the obligations of the optionor and optionee under their respective agreements may be identical to the obligations they would have if the optionor and optionee were actual counterparties to the same agreement. Moreover, the obligations of the exchange under the first agreement instance may be the same as the optionor's obligations under the second agreement instance, and vice versa. By creating separate agreement instances in this manner, the exchange assumes the risk of default by the optionor or optionee. As discussed below, the optionor that enters a created optioned agreement may not have been a party to the exercised option.

Depending on the terms of the option, exercise may occur as the result of an affirmative act by the optionee (e.g., transmitting notification of a desire to exercise). Exercise might also occur automatically. For example, system 100 or another computer system might automatically deem an option to be exercised if certain market conditions occur and the optionee has not provided notification of intent to abandon the option.

Many types of agreements can be the subject of an option, i.e., serve as an optioned agreement. For example, an optioned agreement might be a futures contract. As known in the art, one party to a futures contract is typically known as a “long” or as the holder of a long contract interest. A long “buys” a futures contract and agrees to take “delivery” of the contractual subject matter (or “underlying”) on a future date and to pay contract price. The other party is typically known as a “short” or as a holder of a short contract interest. A short “sells” a futures contract and agrees to provide delivery of the underlying on the contractually specified future date and to accept the contract price. Depending on the futures contract type, delivery may be physical (e.g., a quantity of the underlying is provided at a specified location) or by payment of a cash equivalent. Examples of an underlying include, without limitation, a commodity (e.g., an agricultural, energy, metal or other commodity), a government issued-security (e.g., a United States Treasury Bill or Note), a non-government security (e.g., a bond or stock issued by a corporation), a currency, a market index, etc.

Futures contracts are listed on an exchange. Delivery requirements, maturity date, quantity of the underlying, notional amounts, and other terms of a futures contract may be standardized by the exchange, with only the price being subject to negotiation. Futures contracts may also be multilaterally traded through the exchange. In particular, parties wishing to buy futures contracts submit bids to the exchange. Parties wishing to sell futures contracts submit offers to the exchange. The exchange then matches bids and offers based on price. This matching may be done anonymously and a matched long may never know the identity of the matched short. When a bid and offer are matched, the exchange may then create offsetting contracts so that the matched long is a party to a contract in which the exchange is the short, and so that the matched short is a party to a contract in which the exchange is the long.

An optioned agreement might be a forward contract. Similar to a futures contract, a forward contract may represent an obligation by the contract purchaser (or long) to provide some quantity of an underlying (or some payment based on a quantity of an underlying) on a future date. A forward contract is a form of OTC contract. As such, it is not standardized (or is less standardized than a futures contract). In a forward contract the parties may negotiate numerous terms in addition to contract price. Moreover, forward contracts may be bilaterally negotiated between a long and a short.

Other types of agreements can also be optioned. Without limitation, other types of optioned agreements can include interest rate swaps and credit default swaps. Swaps and other types of agreements can be listed (e.g., terms defined by an exchange, multilaterally traded on that exchange) or OTC (e.g., fewer or no terms defined by an exchange, bilaterally traded). A swap may also have a long and a short. For example, in a so-called plain vanilla swap the long may agree to pay according to a floating interest rate and receive payment according to a fixed interest rate, while the short may agree to pay according to the fixed interest rate and receive payment according to the floating interest rate. In swaps and other types of optioned agreements, longs and shorts may sometimes be defined in other ways.

An option may also have a “strike price.” When an option is exercised, the strike price is a price at which the optioned agreement is entered. For example, the strike price of an optioned futures contract may represent the price at which the optionee will buy the futures contract, i.e., the price that the optionee (in its role as a party to the optioned futures contract) will pay to a short at maturity of that futures contract. Similarly, the strike price of an optioned forward contract may be the price that the optionee (in its role as a party to the optioned forward contract) will pay to a short at maturity of the forward contract. In an interest rate swap, the strike price may represent one of the interest rates that will be paid under the swap. If the optioned agreement is a simple fixed-for-floating interest rate swap, for example, the strike price may be a fixed interest rate that the optionee (in its role as a party to optioned swap) agrees to receive in return for payment of according to a floating rate defined in the swap (e.g., the London Inter-Bank Offered Rate (LIBOR) or a rate based thereon).

A position of a party with regard to a particular type of option may be exercisable in a piecemeal and/or partial manner. For example, a party may hold optionee interests in ten options. Each of those options may entitle that party to enter into a separate instance of a contract having a designated notional amount, at designated strike price and/or under other common terms. The optionee may exercise five of those options some time prior to the expiration of those options. At one or more later times that are also prior to expiration, the optionee might exercise some or all of the other five options. As another example, an option might correspond to an optioned agreement having a variable size. Under such an option, for instance, the optionee might have the right to enter into a contract having a notional size of up a maximum amount at a designated strike price (e.g., a designated currency exchange rate) that varies based on the notional amount. The optionee may decide to exercise that option so as to acquire an interest in an optioned agreement having a notional less than the maximum.

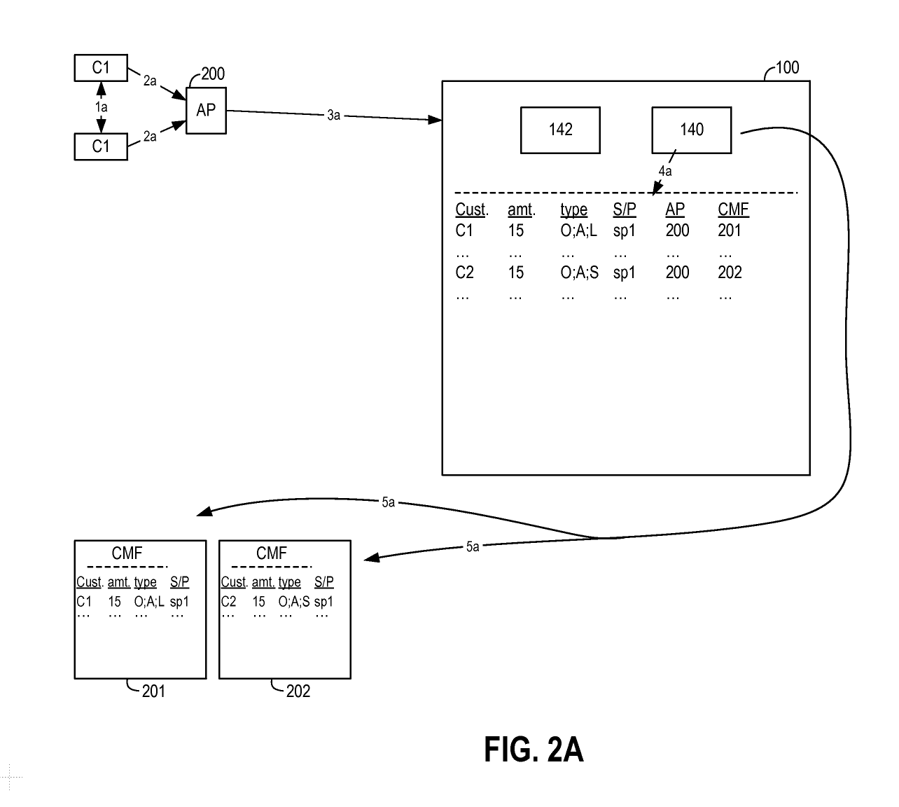

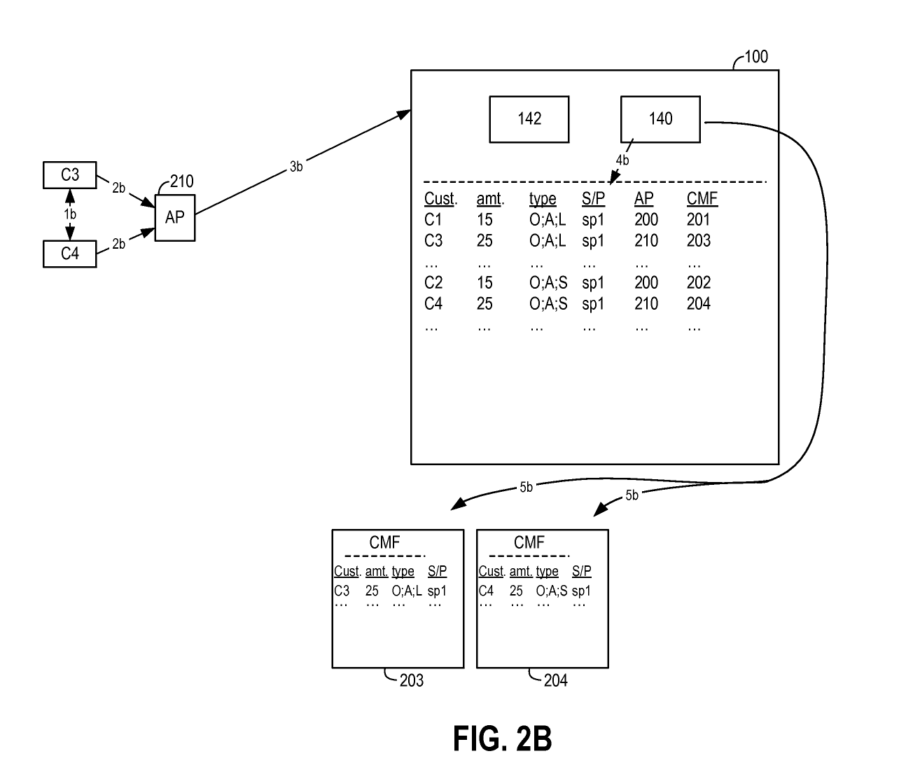

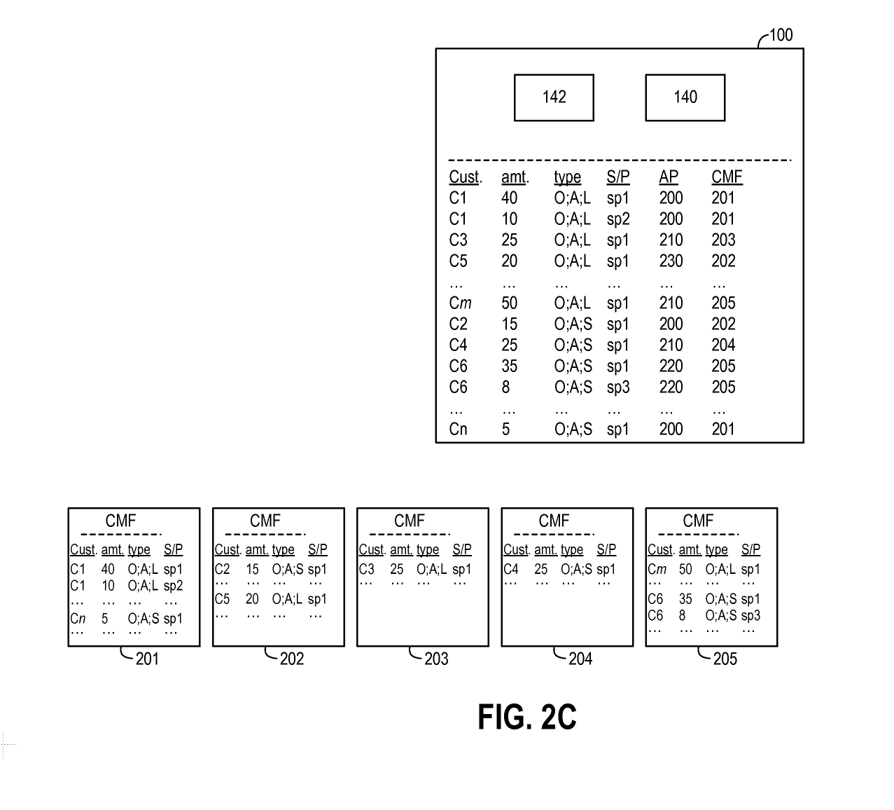

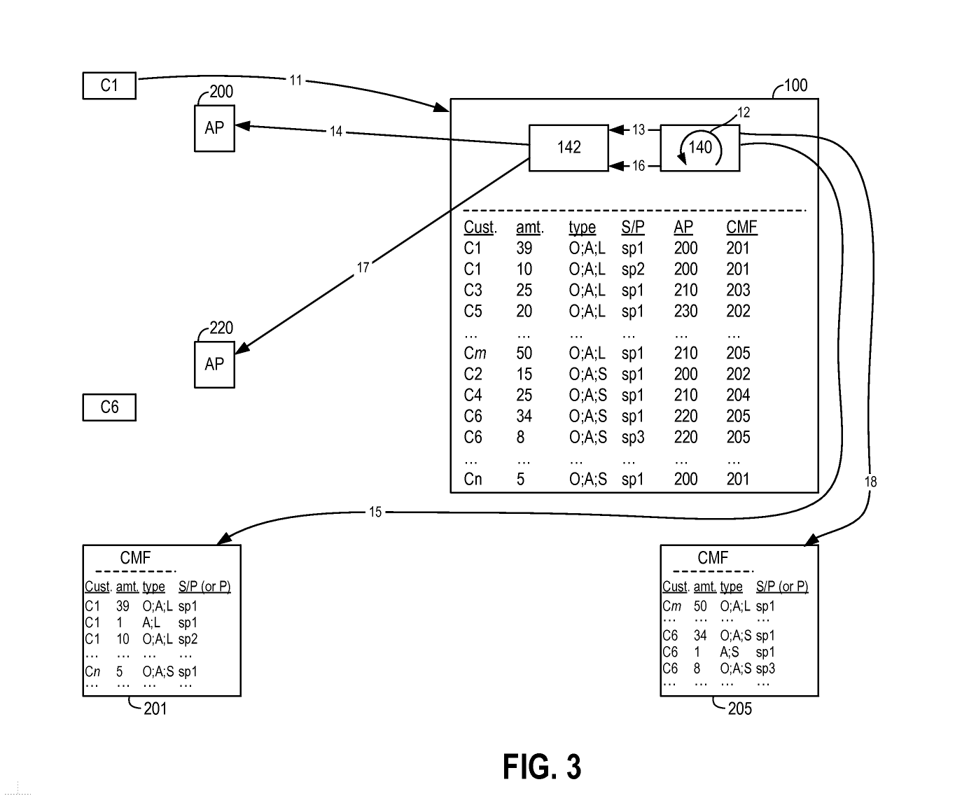

FIGS. 2A through 3 are block diagrams showing operations, according to some embodiments, performed by exchange computer system 100 in connection with OTC agreements relating to OTC options. In other embodiments, however, computer system 100 may perform similar operations in connection with options listed and multilaterally traded through system 100 or through a computer system associated with a different exchange. Although the below description may refer to performance of operations by specific modules of system 100, in other embodiments one or more of such operations might be performed by a different module and/or by a computer system that is not an exchange computer system.

The operations in FIGS. 2A through 3 are described using a hypothetical OTC option type. Under an option of this type, which is called an “A option” for convenience, the optionee has the right to exercise the option and enter into an optioned contract. Also for convenience, that optioned contract will be called an “A contract.” An A contract could be a forward contract, a swap, or other type of agreement. A party's position in A options can be quantified by the number of A options interests held by that party. For other types of options, a party's position might be quantified in a different manner. For example, and as indicated above, an option might permit an optionee to enter into an optioned agreement of up to a maximum notional amount. A party's position in such options might be quantified by the maximum notional amount of such an option in which a party holds an interest, or by the combined maximum notional amounts of such options in which a party holds interests.

In FIG. 2A, and as indicated by the arrow of operation 1a, customers C1 and C2 bilaterally negotiate an agreement by which customer C1 will hold optionee interests in each of fifteen A options and customer C2 will hold optionor interests in each of those fifteen A options. For convenience, the examples of FIGS. 2A through 3 assume that an optionee of an A option holds a long interest in that option and has the right (upon exercise) to take a long interest in an A contract. The examples of FIGS. 2A through 3 further assume that an optionor of an A option holds a short interest in that option and has the obligation to take a short interest in an A contract if selected to do so by computer system 100. In other embodiments, however, the roles might be reversed. For example, the holder of a long option interest (corresponding to a potential long interest in an optioned contract) may be the optionor and the holder of the short option interest (corresponding to a potential short interest in an optioned contract) could be the optionee.

After operation 1a, and as shown by the arrows of operation 2a, customers C1 and C2 execute the agreement regarding the fifteen A options by inputting input data into an affirmation platform computer system (“affirmation platform”) 200. The input data could include identities of customers C1 and C2, details of the executed agreement and of the A options, and details of the optioned A contracts. The input information may also identify a clearing member firm 201 associated with customer C1 and a clearing member firm 202 associated with customer C2. Each of customers C1 and C1 may comprise a computer system, with communications of operations 1a and 2a and other communications being performed with the customers' computer systems. For example, each of customer C1 and customer C2 may comprise a computer such as computer 120 and/or a local area network of computers such as LAN 124, computer 116 and computer 118. Affirmation platform 200 may similarly comprise a computer system such as computer 120 and/or LAN 124, computer 116 and computer 118. Examples of affirmation platforms that may be used in connection with various embodiments include those that provide services such as Bloomberg VCON, CME Clearport, ICE Link, Javelin, MarkitSERV and TradeWeb. In some embodiments, and as shown in FIG. 2A, an affirmation platform may be external to and distinct from exchange computer system 100 (or other computer system performing one or more operations described in connection with system 100). In other embodiments, an affirmation platform may be part of system 100 (or other computer system performing one or more operations described in connection with system 100).

After receiving data from the transmissions in operation 2a, affirmation platform 200 sends customers C1 and C2 confirmation (not shown) of the executed agreement and of the resulting fifteen executed A options. Affirmation platform 200 also forwards data regarding those fifteen executed A options to system 100, as shown by operation 3a. That forwarded data may include the same information provided by customers C1 and C2 at operation 2a, data identifying affirmation platform (AP) 200, etc. System 100 routes the data of operation 3a to clearinghouse module 140. Clearinghouse module 140 then stores data regarding the fifteen A options in operation 4a. The stored data may include data identifying each of customers C1 and C2, data identifying affirmation platform 200, data indicating the types of interests in the A options (e.g., O=option, A=A contract, L=long or S=short), and data indicating clearing member firms (CMF) associated with customers C1 and C2. The stored data may further include a strike price (S/P) or other data that can be used when matching a long interest in an exercised option with a short interest in a similar option, as described below. Data stored by module 140 and/or by other modules may include other types of information. For example, EA module 142 and/or clearinghouse module 140 may store data indicating the expiration date of A options and/or instructions for automatic exercise of A options.

Clearinghouse module 140 forwards data regarding the executed A options to computer systems of clearing member firms 201 and 202 respectively associated with customers C1 and C2, as shown at operation 5a. In response, the computer systems of clearing member firms 201 and 202 store data regarding those A options. At the conclusion of the operations shown in FIG. 2A, customer C1 has a position in A options that includes fifteen A option long interests at a strike price of sp1. Customer C2 has a position in A options that includes fifteen A option short interests at a strike price of sp1.

In FIG. 2B, and as shown by operation 1b, customers C3 and C4 bilaterally negotiate an agreement by which customer C3 acquires twenty-five A option long interests at strike price sp1 and customer C4 acquires twenty-five A option short interests at strike price sp1. After operation 1b, and as shown by the arrows of operation 2b, customers C3 and C4 execute their option agreement by transmitting data to an affirmation platform 210. The transmitted data could include information analogous to the information provided in operation 2a of FIG. 2a (e.g., identities of customers C3 and C4, details of the A options, details of the optioned A contracts, identities of clearing member firms associated with customers C3 and C4). Each of customer C3, customer C4 and affirmation platform 210 may comprise a computer system in a manner similar to that described in connection with customers C1 and C2 and affirmation platform 200. Affirmation platform 210 is a separate affirmation platform that may be operated by an entity separate from the entity operating affirmation platform 200. In some embodiments, however, customers C3 and C4 might alternatively utilize affirmation platform 200.

After receiving data in the transmission of operation 2b, affirmation platform 210 may send customers C3 and C4 confirmation (not shown) of the executed agreement and of the resulting twenty-five executed A options. Affirmation platform 210 also forwards data to system 100 regarding those twenty-five A options, as shown by operation 3b. That forwarded data may include the same information provided by customers C3 and C4 at operation 2b, data identifying affirmation platform 210, etc. System 100 routes the data from the transmission of operation 3b to clearinghouse module 140. Clearinghouse module 140 stores data regarding the twenty-five A options, as indicated by operation 4b. Clearinghouse module 140 and/or EA module 142 may also store data indicating the expiration date of the twenty-five A options and/or instructions for automatic exercise of those A options. Clearinghouse module 140 forwards data regarding the twenty-five A options to computer systems of clearing member firms 203 and 204 respectively associated with customers C3 and C4, as shown by operation 5b. In response, the computer systems of clearing member firms 203 and 204 store data regarding the executed options. At the conclusion of the operations shown in FIG. 2B, customer C3 has a position in A options that includes twenty-five A option long interests at strike price sp1. Customer C4 has a position in A options that includes twenty-five A option short interests at strike price sp1.

One or more additional series of option execution processing operations similar to those of FIGS. 2A and 2B continue with regard to additional bilaterally negotiated agreements for A options. The operations in those additional series may involve additional customers, additional affirmation platforms and additional clearing member firms. In some cases, however, a customer, affirmation platform and/or clearing member firm might be involved in more than one series of option execution processing operations. For example, another pair of bilaterally negotiating customers might utilize affirmation platform 200 or affirmation platform 210. As another example, other customers might also be associated with one of clearing member firms 201, 202, 203 or 204. As yet a further example, customer C1 might later acquire additional A option long interests, customer C4 might later acquire additional A option short interests, etc.

FIG. 2C shows data stored after several additional series of option execution processing operations, similar to the series of FIG. 2A and to the series of FIG. 2B, have been performed. In addition to the data stored during operations of FIGS. 2A and 2B, clearinghouse module 140 has further stored data regarding A option interests of customer C5, customer C6, and additional customers through and including customers Cm and Cn. The letters “m” and “n” refer to arbitrary integers and indicate, in combination with the ellipsis between C5 and Cm and the ellipsis between C6 and Cn, that there could be any number of customers with A option long interests and any number of customers with A option short interests. As seen in FIG. 2C, customer C1 has acquired an additional twenty-five long interests in A options at strike price sp1. Customer C1 has also acquired ten long interests in A options at strike price sp2. Customer C5 has twenty long interests in A options at strike price sp1 processed through affirmation platform 230. Customer Cm has fifty long interests in A options at strike price sp1 processed through affirmation platform 210. Customer C6 has thirty-five short interests in A options at strike price sp1 processed through affirmation platform 220. Customer C6 also has eight short interests in A options at strike price sp3, also processed through affirmation platform 220. Customer Cn has five short interests in A options processed through affirmation platform 200. Although the number of A option long interests shown in FIG. 2C for customers C1, C3, C5 and Cm at strike price sp1 is different from the number of A option short interests shown for customers C2, C4, C6 and Cn at strike price sp1, additional long and short interests in A options at strike price sp1 could be held by the other customers indicated by the ellipses between C5 and Cm and C6 and Cn.

FIG. 3 shows operations performed by exchange computer system 100 in connection with exercise of an option and assignment of an interest in an optioned contract. Although the below description may refer to performance of operations by specific modules of system 100, in other embodiments one or more of such operations might be performed by a different module. In the example of FIG. 3, customer C1 decides to exercise a portion of the options on which one of its A option interests are based. In particular, customer C1 decides to execute a single A option at strike price sp1. Accordingly, and as shown by operation 11, customer C1 transmits data to exchange computer system 100 that includes exercise instructions. For convenience, FIG. 3 shows an embodiment in which customer C1 transmits exercise instructions directly to system 100. In other embodiments, exercise instructions may be received through a separate computer system (e.g., of a broker, affirmation platform or other service associated with an exercising customer). In some embodiments, and as explained below, exercise instructions received in a module of exchange computer system 100 may emanate from that module or from another module within computer system 100. For example, module 140 may receive exercise instructions from an internal software routine (e.g., of EA module 142 or clearinghouse module 140) that automatically exercises an option on occurrence of certain conditions.

The exercise instructions from customer C1 are received by EA module 142 and routed to clearinghouse module 140. As indicated by operation 12, clearinghouse module 140 then selects one or more A option short interests to match the long interest in the exercised A option. In the example of FIG. 3, a short interest matches a long interest if it has the same strike price. Thus, clearinghouse module 140 selects one of the A option short interests having a strike price sp1. In other embodiments, one or more other parameters may be included as part of matching optionee and optionor interests.

Clearinghouse module 140 performs the selection in operation 12 without regard to whether a selected A option short interest is based on the option that is being exercised. In some embodiments, clearinghouse module 140 performs the selection of operation 12 by randomly selecting one of the open A option short interests. Other algorithms can also be used, as discussed below.

As part of operation 12, clearinghouse module 140 also assigns a short interest in an A contract to the holder of the selected A option short interest. In the example of FIG. 3, clearinghouse module 140 selects an A option short interest held by customer C6. In operation 13, clearinghouse module 140 provides data to EA module 142 confirming exercise of the A option long interest, in response to which EA module 142 updates a database to reflect an “exercised” status for the exercised A option. EA module 142 then transmits data confirming the exercise to an affirmation platform associated with the holder of the long interest in the exercised option (operation 14). In the example of FIG. 3, the data of operation 14 is transmitted to affirmation platform 200 associated with customer C1.

As shown by operation 15, clearinghouse module 140 also transmits data to a computer system of a clearing member firm associated with the holder of the long interest in the exercised A option. In the current example, the data of operation 15 is transmitted to the computer system of clearing member firm 201 associated with customer C1. The data transmitted in operation 15 indicates that the option is now terminated, and that customer C1 now has a long interest in an A contract created because of the exercise. Based on the received data, the computer system of clearing member firm 201 updates its database accordingly. For convenience, FIG. 3 shows data for a created contract and option data in the same CMF table. Although the example of FIG. 3 suggests that operation 15 occurs after operations 13 and 14, operation 15 could be performed concurrently with (or before) one or more of operations 13 and 14.

As shown at operation 16, clearinghouse module 140 provides data to EA module 142 confirming assignment of an A contract short interest to the holder of the selected A option short interest. In the current example, that data identifies customer C6. In response, EA module 142 updates a database to reflect an “assigned” status for customer C6 and an A contract short interest. EA module 142 then transmits data indicating that assignment to an affirmation platform associated with the holder of the selected A option short interest, which holder is now the holder of an A contract short interest (operation 17). In the example of FIG. 3, the data of operation 17 is transmitted to affirmation platform 220 associated with customer C6. Affirmation platform 220 may then forward this assignment notification to customer C6 (not shown).

Although the example of FIG. 3 suggests that operations 16 and 17 occur after operations 13-15, this need not be the case. Operations 16 and 17 could be performed concurrently with (or before) one or more of operations 13-15. In at least some embodiments, operations 16 and 17 are performed substantially immediately (e.g., within several minutes or less) after assignment in operation 12. In certain embodiments, operations 16 and 17 are performed prior to the end of the trading day on which the assignment of operation 12 occurs.

As shown by operation 18, clearinghouse module 140 also transmits data to a computer system of a clearing member firm associated with the holder of the selected A option short interest. In the current example, the data of operation 18 is transmitted to the computer system of clearing member firm 205 associated with customer C6. The data transmitted in operation 18 indicates that the selected A option short interest is now terminated, and that customer C6 now has a short interest in an A contract. Based on the received data, the computer system of clearing member firm 205 updates its database accordingly. Although the example of FIG. 3 suggests that operation 18 occurs after operations 13-17, operation 18 could be performed concurrently with (or before) one or more of operations 13-17.

Although not shown in FIG. 3, in some embodiments clearinghouse module 140 may perform additional operations so as to create and hold offsetting contracts as a result of the exercised option. For example, clearinghouse module 140 may create a first A contract and assign a short contract interest in that first contract to the exchange, with the exchange becoming the actual counterparty to the A contract in which customer C1 holds a long interest. Similarly, clearinghouse module 140 may create a second A contract and assign a long interest to the exchange, with the exchange becoming the actual counterparty to the A contract in in which customer C6 holds a short interest.

In the example of FIG. 3, customer C1 only exercised one option. In some embodiments, the data provided during operation 11 may instruct exchange computer system 100 to exercise multiple options. In such a case, system 100 in certain embodiments would sequentially repeat operations 12 through 18 for each of the exercised options. For example, assume that in operation 11 customer C1 had instructed system 100 to exercise two options having strike price sp1 and one option having strike price sp2. System 100 may then perform operations 12-18 for a first of the exercised options at strike price sp2, resulting in an A contract interest being assigned to a holder of one of the open A option (at strike price sp1) short interests (e.g., customer C6 as in the previous example). System 100 may then perform operations 12-18 for the second of the exercised options having strike price sp1, resulting in a subsequent A contract interest being assigned to a holder of one of the remaining open A option (strike price sp1) short interests. The subsequent A contract interest would not necessarily be assigned to customer C6. System 100 may then perform operations 12-18 for the exercised option having strike price sp2, resulting in a subsequent A contract interest being assigned to a holder of an open A option (strike price sp2) short interest.

In some embodiments, and as indicated above, an option might permit an optionee to enter into an optioned agreement of up to a maximum notional amount. In some such embodiments, module 140 may select multiple optionor interests in response to exercise of a single option. For example, assume an optionee of an option has the right to enter into an FX forward contract having a maximum notional value of 100 million units of a first currency and that the strike price is an exchange rate e1 for that first currency relative to a second currency. If the option is exercised as to the entire 100 million unit maximum notional, module 140 might match portions of that optionee interest against portions of different optionor interests. For example, module 140 might match a portion of the optionee interest corresponding to a 50 million unit notional against an optionor interest having a 50 million unit maximum notional and the e1 strike price. Module 140 might then match another portion of the optionee interest corresponding to a 50 million unit notional against a 50 million unit portion of an optionor interest having a 75 million unit maximum notional and the e1 strike price.

In some cases, a holder of an open option position may notify exchange computer system 100 that it is abandoning the related option and will not exercise it. In such a case, clearinghouse module 140 may update its database to reflect the abandoned option. Clearinghouse module 140 may also transmit data to a computer system of a clearing member firm associated with the holder of the position related to the abandoned option so as to notify the clearing member firm of the abandonment.

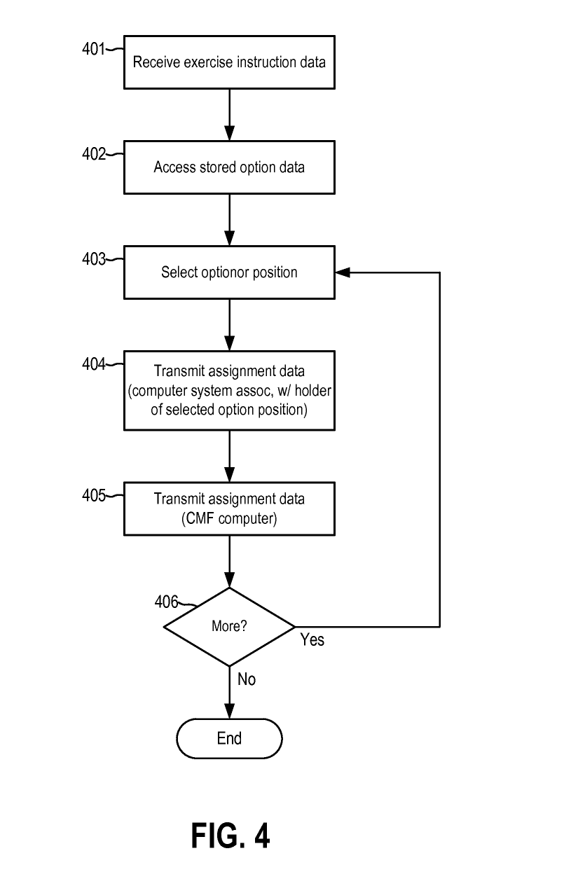

FIG. 4 is a flow chart showing steps performed in methods according to some embodiments. The flow chart of FIG. 4 encompasses various operations described in connection with FIG. 3, as well as operations in other embodiments.

In step 401, a computer system receives exercise instruction data. In the example of FIG. 3, the computer system is exchange computer system 100. This need not be the case, however, and methods according to FIG. 4 could be performed using other types of computer systems. The exercise instruction data received in step 401 indicates the exercise of an option on which an optionee interest is based. There may be additional similar optionee interests based on options of the same (or similar type). Multiple optionor positions are also based on those options.

The data received in step 401 could be received from a source external to the computer system, e.g., from a customer or a customer's computer system as in the example of FIG. 3, from an affirmation platform or other system utilized by a holder of the interest in the exercised option, etc. The data could also be received from a software routine or other source within the computer system. For example, the computer system performing the method of FIG. 4 could execute a separate program or routine that monitors market conditions relevant to an optioned contract. When a relevant commodity, interest rate or other subject matter obtains a market value that has a predefined relationship to a strike price of an option or other parameter, that separate program or routine may automatically generate an instruction to exercise an option. The predefined relationship between strike price (or other parameter) and a market value (or other parameter) could be configured based on data provided by the holder of the optionee position. That holder might also configure the computer system to automatically exercise an option based on other conditions. For example, the holder might instruct the computer system to exercise an option on (or immediately prior to) the option expiration date if a market price has a particular relationship to a strike price (e.g., higher than the strike price, lower than the strike price, within a certain range of the strike price).

In step 402, the computer system accesses stored option data. The option data identifies multiple optionor interests based on options of the same type as the exercised option. As to each of those options, an optionee (holding an optionee interest based on the option) has the right (but not the obligation) to enter into an optioned agreement and an optionor (holding an optionor interest in the option) has the obligation to enter into an optioned agreement if selected to do so. The optioned agreement for each of the options may be of the same type.

In step 403, the computer system selects an optionor interest that matches the exercised option. In particular, the computer system may identify an optionor interest in an option based on an option of the same type as the exercised option, and for which other parameters also match the optionee interest in the exercised option. One of those parameters may include strike price. Other parameters could also or alternatively be matched.

For some types of options, selecting an optionor interest in response to option execution may be one-to-one matching of optionee and optionor interests. For example, and as described above for A options, some types of options may only permit an optionee (and obligate an optionor) to enter a single contract of a fixed size. In other circumstances, the selecting may be a one-to-several matching of optionee and optionor interests. As discussed above in connection with a hypothetical option on a first currency FX forward contract, a portion of an optionee's interest may be matched against one optionor interest, another portion of the optionee's interest matched against a different optionor interest, etc. In some embodiments, such one-to-several matching may occur if no single optionor interest is of sufficiently large size to completely match an optionee interest. Such one-to-several matching may also be performed for other reasons. For example, a computer system might automatically perform one-to-several matching with regard to optionee interests over a threshold size so as to more evenly spread risk among optionor interests.

The selecting of step 403 may be performed without regard to whether the selected optionor interest is based on the exercised option. In some embodiments, the computer system may perform this selection randomly. For example, all open optionor interests potentially matching the optionee interest could be assigned an identifying number. The computer system could then randomly select one of those identifying numbers. Other types selection algorithms could be utilized in step 403. For example, a selection algorithm could be time based (e.g., first in first out (FIFO), last in first out (LIFO)) or could combine random selection with a time based component.

As part of step 403, the computer system may also assign a first contract interest in a created optioned contract to the optionee of the exercised option and a second contract interest in a created optioned contract to the holder of the selected optionor interest. In the example of FIG. 3, for example, exchange computer system 100 assigned a long A contract interest to customer C1 and a short A contract interest to customer C6.

In step 404, the computer system transmits assignment data indicating assignment of a contract interest in an optioned contract. The computer system may transmit this data to a computer system associated with a holder of the selected optionor interest (e.g., to an affirmation platform associated with the holder of the selected optionor interest). In the example of FIG. 3, for example, computer system 100 transmitted assignment data to affirmation platform 220 associated with customer C6.

In some embodiments, the data of step 404 is transmitted immediately or substantially immediately upon the selection of the optionor interest. In other embodiments, the data of step 404 may be transmitted after expiration of a timer or at some other predefined time. As one example, the data of step 404 may be transmitted as part of a batch processing of exercised options performed at periodic intervals (e.g., every twenty minutes) by the computer system. As another example, the data of step 404 may be transmitted at the expiration of a time applicable the exercised option and/or to one or more other options of the same type (e.g., option expiration). As but another example, the data of step 404 may be transmitted at the end of a trading day on which the selection of step 403 occurs.

In at least embodiments, the computer system to which data is transmitted in step 404 is a computer system other than a clearing member computer system. In at least some such embodiments, the same computer system the receives exercise instructions, performs the selection of an optionor interest, and notifies the affected holder of the selected optionor interest.

In step 405, the computer system transmits data indicating the assignment of the contract interest to a computer system of a clearing member firm associated with the holder of the selected optionor interest. In the example of FIG. 3, for example, system 100 transmitted data to a computer system of clearing member firm 205 associated with customer C6.

Although not shown in FIG. 4, additional communications may also be sent with regard to the optionee interest in the exercised option. For example, the computer system may notify the holder of that optionee interest (or an affirmation platform or other computer system associated with that holder) to confirm execution and/or optioned contract assignment, may notify a computer system of a clearing member firm associated with that holder, etc. Examples of these additional communications include those of operations 14 and 15 in FIG. 3. These additional communications can be performed as part of step 404 and/or step 405, or as separate steps before, after, or intermingled in steps 404 and 405.

After step 405 (or after one of the additional communication steps, if such steps are performed after step 405), the computer system determines in step 406 if there are additional exercised options or portions thereof to be processed. For example, the communication received in step 401 may have indicated exercise of multiple options. As another example, it may be necessary to select additional optionor interests if the optionee interest is of a certain value and only a portion of that value has been matched. If there are additional exercised options or portions thereof to be processed, the computer system returns on the “yes” branch to step 403. If not, the computer system proceeds on the “no” branch and the method ends.

Other embodiments may include features in addition to and/or instead of features described above. Various above-described method steps can be combined, rearranged, omitted and/or performed in a different manner. As previously indicated, embodiments include methods that process data in connection with exercise and assignment of exchange-traded (e.g., exchange listed) options that pertain to exchange-traded futures and other exchange-traded contracts. In connection with OTC options, a computer system according to some embodiments (e.g., computer system 100) may be further configured to analyze received data regarding executed OTC options (e.g., data such as that transmitted in operation 3a in FIG. 2A and operation 3b in FIG. 2B). As part of that analysis, the computer system could determine if optioned contracts for OTC options are sufficiently similar to optioned contracts of other OTC options permit selection of optionor interests in those OTC options as a result of exercising one of those other OTC options. Such an analysis could compare optioned contract parameters such as underlying, price, quantity, maturity date, etc.

### CONCLUSION

The foregoing description of embodiments has been presented for purposes of illustration and description. The foregoing description is not intended to be exhaustive or to limit embodiments to the precise form explicitly described or mentioned herein. Modifications and variations are possible in light of the above teachings or may be acquired from practice of various embodiments. For example, one of ordinary skill in the art will appreciate that some steps illustrated in the figures may be performed in other than the recited order, and that one or more steps illustrated may be omitted in one or more embodiments. The embodiments discussed herein were chosen and described in order to explain the principles and the nature of various embodiments and their practical application to enable one skilled in the art to make and use these and other embodiments with various modifications as are suited to the particular use contemplated. Any and all permutations of features from above-described embodiments are the within the scope of the invention.

1. A method comprising:
(a) receiving exercise instruction data in a computer system, the exercise instruction data indicating exercise of an over the counter (OTC) option, wherein optionee and optionor interests are based on the exercised OTC option;
(b) accessing stored option data by the computer system, the option data identifying multiple optionor interests based on OTC options of the same type as the exercised OTC option;
(c) selecting one of the identified optionor interests, wherein the selecting is performed by the computer system, in response to receipt of the exercise instruction data, and without regard to whether the selected interest is based on the exercised OTC option; and
(d) transmitting, from the computer system and to a computer system associated with a holder of the selected interest, assignment data indicating assignment of an interest in an optioned contract created as a result of the exercise.

2. The method of claim 1, further comprising:
receiving data indicating execution of the exercised OTC option and of the OTC options of the same type as the exercised OTC option;
for each of those executed OTC options, storing data identifying at least one optionee interest in the executed OTC option and at least one optionor interest in the executed OTC option; and
forwarding, from the computer system and to computer systems associated with parties to the executed OTC options, data indicating the optionee interests and the optionor interests.

3. The method of claim 2, wherein (c) comprises not selecting the optionor interest for which data was stored in connection with the exercised OTC option.

4. The method of claim 2, wherein receiving data indicating execution of OTC options comprises receiving that data from one or more computer systems external to the computer system.

5. The method of claim 1, wherein (c) comprises randomly selecting one of the optionor interests.

6. The method of claim 1, wherein the transmitting of (d) is performed substantially immediately after the selection of (c).

7. One or more non-transitory computer-readable media storing computer executable instructions that, when executed, cause a computer system to perform operations that include:
(a) receiving exercise instruction data, the exercise instruction data indicating exercise of an over the counter (OTC) option, wherein optionee and optionor interests are based on the exercised OTC option;
(b) accessing stored option data, the option data identifying multiple optionor interests based on OTC options of the same type as the exercised OTC option;
(c) selecting one of the identified optionor interests, wherein the selecting is performed in response to receipt of the exercise instruction data, and without regard to whether the selected interest is based on the exercised OTC option; and
(d) transmitting, to a computer system associated with a holder of the selected interest, assignment data indicating assignment of an interest in an optioned contract created as a result of the exercise.

8. The one or more non-transitory computer-readable media of claim 7, wherein the stored instructions further comprise instructions that, when executed, cause the computer system to perform operations that include:
receiving data indicating execution of the exercised OTC option and of the OTC options of the same type as the exercised OTC option;
for each of those executed OTC options, storing data identifying at least one optionee interest in the executed OTC option and at least one optionor interest in the executed OTC option; and
forwarding, to computer systems associated with parties to the executed OTC options, data indicating the optionee interests and the optionor interests.

9. The one or more non-transitory computer-readable media of claim 8, wherein (c) comprises not selecting the optionor interest for which data was stored in connection with the exercised OTC option.

10. The one or more non-transitory computer-readable media of claim 8, wherein receiving data indicating execution of OTC options comprises receiving that data from one or more computer systems external to the computer system.

11. The one or more non-transitory computer-readable media of claim 7, wherein (c) comprises randomly selecting one of the optionor interests.

12. The one or more non-transitory computer-readable media of claim 7, wherein the transmitting of (d) is performed substantially immediately after the selection of (c).

13. A computer system comprising:
at least one processor; and
at least one non-transitory memory, wherein the at least one non-transitory memory stores instructions that, when executed, cause the computer system to perform operations that include
(a) receiving exercise instruction data, the exercise instruction data indicating exercise of an over the counter (OTC) option, wherein optionee and optionor interests are based on the exercised OTC option,
(b) accessing stored option data, the option data identifying multiple optionor interests based on OTC options of the same type as the exercised OTC option,
(c) selecting one of the identified optionor interests, wherein the selecting is performed in response to receipt of the exercise instruction data, and without regard to whether the selected interest is based on the exercised OTC option, and
(d) transmitting, to a computer system associated with a holder of the selected interest, assignment data indicating assignment of an interest in an optioned contract created as a result of the exercise.

14. The computer system of claim 13, wherein the stored instructions further comprise instructions that, when executed, cause the computer system to perform operations that include
receiving data indicating execution of the exercised OTC option and of the OTC options of the same type as the exercised OTC option,
for each of those executed OTC options, storing data identifying at least one optionee interest in the executed OTC option and at least one optionor interest in the executed OTC option, and
forwarding, to computer systems associated with parties to the executed OTC options, data indicating the optionee interests and the optionor interests.

15. The computer system of claim 14, wherein (c) comprises not selecting the optionor interest for which data was stored in connection with the exercised OTC option.

16. The computer system of claim 14, wherein receiving data indicating execution of OTC options comprises receiving that data from one or more computer systems external to the computer system.

17. The computer system of claim 13, wherein (c) comprises randomly selecting one of the optionor interests.

18. The computer system of claim 13, wherein the transmitting of (d) is performed substantially immediately after the selection of (c).

19. A method comprising:
(a) receiving exercise instruction data in a computer system, the exercise instruction data indicating exercise of an option, wherein optionee and optionor interests are based on the exercised option;
(b) accessing stored option data by the computer system, the option data identifying multiple optionor interests based on options of the same type as the exercised option;
(c) selecting one of the identified optionor interests, wherein the selecting is performed by the computer system, in response to receipt of the exercise instruction data, and without regard to whether the selected interest is based on the exercised option; and
(d) transmitting assignment data indicating assignment of an interest in an optioned contract created as a result of the exercise, wherein the assignment data is transmitted from the computer system and to a computer system associated with a holder of the selected interest, and wherein the computer system associated with the holder of the selected interest is not associated with a clearing member firm.

20. The method of claim 19, wherein the transmitting of (d) is performed substantially immediately after the selection of (c).
